(19) United States
(12) Patent Application Publication
(10) Pub. No.: US 2026/0105378 A1
(43) Pub. Date: Apr. 16, 2026

(54) METHOD FOR TRAINING LARGE MODEL, ELECTRONIC DEVICE AND STORAGE MEDIUM

(71) Applicant: BEIJING BAIDU NETCOM SCIENCE TECHNOLOGY CO., LTD., Beijing (CN)

(72) Inventors: Meng TIAN, Beijing (CN); Xin WANG, Beijing (CN); Zhongjun HE, Beijing (CN); Xing YUAN, Beijing (CN); Hua WU, Beijing (CN)

(73) Assignee: BEIJING BAIDU NETCOM SCIENCE TECHNOLOGY CO., LTD., Beijing (CN)

(21) Appl. No.: 19/418,624

(22) Filed: Dec. 12, 2025

(30) Foreign Application Priority Data
May 30, 2025 (CN) 202510726119.5

(51) Int. Cl. G06N 20/00

(52) U.S. Cl. CPC G06N 20/00

(57) ABSTRACT

Provided is a method for training a large model, an electronic device and a storage medium, relating to the field of computer technology, and in particular to the fields of data processing, deep learning, multimodal large model and other technologies. The method includes: inputting a query into a first large model so that the first large model responds to the query to obtain a response to the query; inputting the query and the response into the first large model so that the first large model evaluates and corrects the response to obtain an evaluation result and a correction result of the response; and fine-tuning the first large model based on at least one of the query, the response, the evaluation result or the correction result. The present disclosure can improve the accuracy and reliability of the response of the large model.

### CROSS-REFERENCE TO RELATED APPLICATIONS

The present application claims priority to Chinese Patent Application No. CN202510726119.5, filed with the China National Intellectual Property Administration on May 30, 2025, the disclosure of which is hereby incorporated herein by reference in its entirety.

### TECHNICAL FIELD

The present disclosure relates to the field of computer technology, and in particular to the fields of data processing, deep learning, multimodal large model and other technologies.

### BACKGROUND

In recent years, the large model technology has developed rapidly, shows great potential in many fields, and effectively promotes the intelligent upgrade of various industries. However, with the widespread application of large models, errors generated during data processing have gradually been exposed, affecting the accuracy and reliability of the response results. Therefore, how to reduce the data processing errors of large models has become a problem to be solved urgently.

### SUMMARY

The present disclosure provides a method and an apparatus for training a large model, a device and a storage medium.

According to one aspect of the present disclosure, provided is a method for training a large model, including:
inputting a query into a first large model so that the first large model responds to the query to obtain a response to the query;
inputting the query and the response into the first large model so that the first large model evaluates and corrects the response to obtain an evaluation result and a correction result of the response; and
fine-tuning the first large model based on at least one of the query, the response, the evaluation result or the correction result.

According to another aspect of the present disclosure, provided is an apparatus for training a large model, including:
a first input module configured to input a query into a first large model so that the first large model responds to the query to obtain a response to the query;
a second input module configured to input the query and the response into the first large model so that the first large model evaluates and corrects the response to obtain an evaluation result and a correction result of the response; and
a model fine-tuning module configured to fine-tune the first large model based on at least one of the query, the response, the evaluation result or the correction result.

According to yet another aspect of the present disclosure, provided is an electronic device, including:
at least one processor; and
a memory connected in communication with the at least one processor;
where the memory stores an instruction executable by the at least one processor, and the instruction, when executed by the at least one processor, enables the at least one processor to execute the method of any embodiment of the present disclosure.

According to yet another aspect of the present disclosure, provided is a non-transitory computer-readable storage medium storing a computer instruction thereon, and the computer instruction is used to cause a computer to execute the method according to any one of the embodiments of the present disclosure.

According to yet another aspect of the present disclosure, provided is a computer program product including a computer program, and the computer program implements the method according to any one of the embodiments of the present disclosure, when executed by a processor.

The present disclosure can discover possible errors in the response by evaluating and correcting the response by the first large model itself, and further train the first large model based on the query, the response, the evaluation result and the correction result, and can train the first large model to reduce response errors. Also, the trained large model can also proactively discover whether there is an error in the response, thereby achieving the purpose of self-reflection and self-correction, and improving the accuracy and reliability of the large model.

It should be understood that the content described in this part is not intended to identify critical or essential features of embodiments of the present disclosure, nor is it used to limit the scope of the present disclosure. Other features of the present disclosure will be easily understood through the following description.

### BRIEF DESCRIPTION OF THE DRAWINGS

The accompanying drawings are used to better understand the present solution, and do not constitute a limitation to the present disclosure.

FIG. 1 is a schematic diagram of an application scenario according to an embodiment of the present disclosure;

FIG. 2 is an implementation flowchart of a method for training a large model according to an embodiment of the present disclosure;

FIG. 3 is a schematic diagram of a process of training a large model according to an embodiment of the present disclosure;

FIG. 4 is a schematic diagram of hallucination evaluation according to an embodiment of the present disclosure;

FIG. 5 is a schematic diagram of hallucination correction according to an embodiment of the present disclosure;

FIG. 6 is a schematic diagram of model fine-tuning according to an embodiment of the present disclosure;

FIG. 7 is a structural schematic diagram of an apparatus for training a large model 700 according to an embodiment of the present disclosure; and

FIG. 8 shows a schematic block diagram of an exemplary electronic device 800 that may be used to implement the embodiments of the present disclosure.

### DETAILED DESCRIPTION

Hereinafter, descriptions to exemplary embodiments of the present disclosure are made with reference to the accompanying drawings, include various details of the embodiments of the present disclosure to facilitate understanding, and should be considered as merely exemplary. Therefore, those having ordinary skill in the art should realize, various changes and modifications may be made to the embodiments described herein, without departing from the scope of the present disclosure. Likewise, for clarity and conciseness, descriptions of well-known functions and structures are omitted in the following descriptions.

The term “and/or” in the embodiments of the present disclosure indicates that there may be three relationships, for example, A and/or B may represent: only A, both A and B, and only B. The term “at least one” herein indicates any one of many items, or any combination of at least two of the many items, for example, at least one of A, B or C may indicate any one or more elements selected from a set of A, B and C. The terms “first” and “second” herein indicate a plurality of similar technical terms and distinguish them from each other, but do not limit an order of them or limit that there are only two items, for example, a first feature and a second feature indicate two types of features/two features, a quantity of the first feature may be one or more, and a quantity of the second feature may also be one or more.

In recent years, the widespread application of the large model technology has injected strong impetus into the intelligent upgrade of various industries. The large model technology breaks the limitations of traditional industries in data processing and analysis, and realizes the automation and intelligence of service processes, thereby improving the production efficiency, reducing the cost, enhancing the market competitiveness, etc. However, in practical applications, errors caused by large models in data processing have gradually begun to be exposed. For example, hallucination phenomenon is a common type of error in large models.

Taking a multimodal large model as an example, the hallucination phenomenon includes: the large model generates a response not conforming to the visual content during application, or the text description and the generated image content contradict each other, etc. For example, the visual content is a blue car, but the large model gives a description of a red car. Although such response with hallucination may appear to be correct in terms of grammar and logic, the response actually has inaccurate content or is fictive information, reducing the reliability and practicality of the large model. Here, the large model may include a multimodal large model for processing different modal data such as image and text.

In the prior art, the hallucination phenomenon of the large model is mainly reduced by three methods as follows.

(1) Enhance the training data:

The negative sample data and counterfactual data are introduced, and the noise and errors in existing datasets are reduced, where the negative sample data can help the large model clarify the knowledge boundaries, and the counterfactual data can enhance the adaptability of the large model to unconventional situations and thereby enhance the quality of the training data.

For example, the dataset contains instructions in the negative form, to enable the large model to learn to follow the instructions while avoiding the generation of content that does not meet requirements after contacting with these instructions in the training process.

(2) Intervention in the decoding stage:

During the decoding stage in which the large model generates a result, specific strategies such as distortion processing and penalty term can be introduced to optimize the model performance and reduce the excessive reliance on language prior. The distortion processing can break the large model's inherent cognition of conventional language patterns, and the penalty term can constrain the unreasonable generation tendency of the large model, prompting the large model to generate content that is more in line with reality.

For example, the Visual Context Distortion (VCD) method may be used to distort the visual input. By changing the presentation of the visual information, the large model cannot simply rely on language prior to generate content during decoding, but must combine the distorted visual information, thereby effectively reducing the occurrence of hallucination phenomenon.

(3) Human preference alignment:

In order to make the large model generate responses that are more in line with human expectations, the large model may be trained via the human preference alignment method, such as Reinforcement Learning from Human Feedback (RLHF), Direct Preference Optimization (DPO), etc. Such algorithm guides the large model to learn a generation method conforming to human values and needs by collecting the preference feedbacks output by humans for the large model.

For example, the DPO method may generate two responses for the same image, one of which is accurate and the other contains hallucinated content. Then, the two responses are compared to analyze why humans tend to give the accurate response and find out the problem of the large model when generating the response with hallucination. Based on this comparative analysis, the large model is optimized in a targeted manner, and the parameters and generation strategy of the large model are adjusted to enable the large model to reduce hallucinations in subsequent processing, thereby generating responses that are more in line with human expectations.

In the prior art described above, the hallucination problem of the large model has been alleviated to a certain extent, but there are still following shortcomings:

(1) Data limitation:

The current dataset still has significant deficiencies in terms of diversity, coverage and pertinence. Specifically, the automatically synthesized sample data has a deviation from the real data and is difficult to meet the actual requirements of users. Moreover, since the automatically synthesized data cannot accurately reflect the specific scenario in which the large model produces the hallucination problem in actual applications, the effect that can be achieved in solving the hallucination problem is relatively limited.

(2) High cost and low efficiency:

The human preference alignment method can show the certain effectiveness, but the manual annotation of the preference data faces the problems of high cost and low efficiency, making it difficult to generate the preference data for training on a large scale. At the same time, this method lacks the ability to monitor the model effect in real time, further limiting its application in large-scale training scenarios.

(3) Method limitation:

Current existing technologies mainly focus on how to train large models to avoid the occurrence of hallucinations, but do not guide the models to master the ability to actively detect whether there are hallucinations in the generated results, making it difficult to achieve the goals of self-reflection and self-correction. Moreover, the existing technologies all adopt a single-round optimization strategy, making it difficult to improve the effect of hallucination reduction.

In addition to the hallucination problem, similar situations also exist in the existing training methods for other possible problems of large models, making it difficult to effectively improve the accuracy and reliability of large models.

In order to solve the above problems, an embodiment of the present disclosure proposes a method for training a large model. The method for training the large model proposed in the present disclosure can be understood as fine-tuning the pre-trained large model. Here, pre-training refers to pre-training a large model on a large-scale unlabeled dataset. The core idea is to train the general feature representation of the large model through a large amount of data, so that the large model can acquire the basic ability to process data. The pre-trained large model may include Generative Pre-trained Transformer (GPT) and Bidirectional Encoder Representations from Transformers (BERT), etc. Fine-tuning refers to the process of further training the pre-trained large model for a specific task. During fine-tuning, a small amount of data is often used to adjust the parameters of the pre-trained large model to better adapt to the requirement of the specific task.

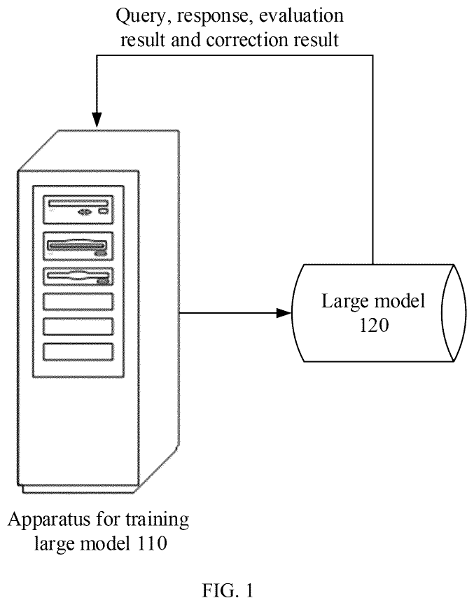

FIG. 1 is a schematic diagram of an application scenario according to an embodiment of the present disclosure. As shown in FIG. 1, the schematic diagram of the application scenario in the embodiment of the present disclosure may include but is not limited to an apparatus for training a large model 110 and a large model 120. The apparatus for training the large model 110 inputs data to the large model 120 and adjusts the parameters of the large model 120 according to the feedback of the large model 120, to realize the training of the large model. The large model may be a pre-trained large model, and the training process may include fine-tuning the pre-trained large model. The embodiment of the present disclosure does not impose any specific limitation on the number of apparatuses for training the large model 110. For example, one or more apparatuses for training the large model 110 may be included in the schematic diagram of the application scenario in the embodiment of the present disclosure.

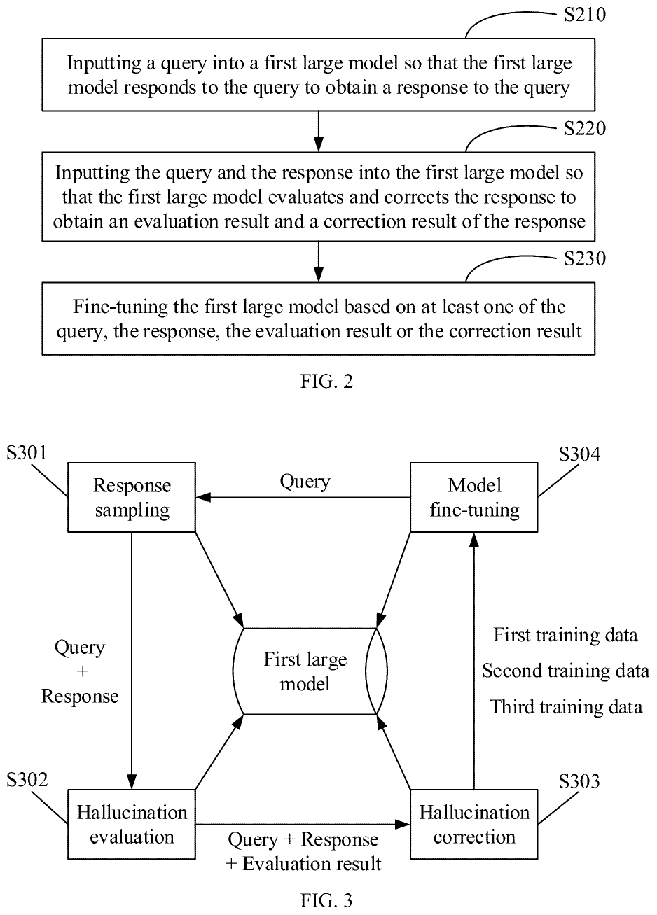

FIG. 2 is an implementation flowchart of a method for training a large model according to an embodiment of the present disclosure, including:
S210: inputting a query into a first large model so that the first large model responds to the query to obtain a response to the query;
S220: inputting the query and the response into the first large model so that the first large model evaluates and corrects the response to obtain an evaluation result and a correction result of the response; and
S230: fine-tuning the first large model based on at least one of the query, the response, the evaluation result or the correction result.

In the embodiment of the present disclosure, the subject that inputs the query to the first large model may be a data processing system, and the data processing system may obtain the query from a data source (such as a database, etc.) through the preset program code and pass the query to the first large model.

Further, after receiving the query, the first large model will activate the internal calculation and processing mechanism to reason, parse and understand the query, and use the learned language patterns, logical rules, etc. to respond to the query. For example, for a scientific knowledge query, the first large model may retrieve the relevant information from its stored knowledge base, and integrate and refine the relevant information.

After the first large model responds, a response to the query may be generated. The response may be a result of the first large model processing the query and may be presented in the form of text.

In the embodiment of the present disclosure, the previous query and the corresponding response may be input into the first large model in a specific data format (such as structured text data), so that the first large model can obtain the query and the response at the same time, so as to conduct the targeted evaluation and correction of the response.

Further, the first large model may evaluate whether a hallucination phenomenon appears in the response according to the query and the response. For example, the first large model may use its own logical reasoning ability to judge whether the statement in the response is reasonable, coherent and consistent with normal thinking logic. If the response contains contradictory statement or the response cannot be deduced from the query, it can be considered that a hallucination phenomenon appears in the response. Based on the evaluation of the response, the first large model may use its own knowledge reserves and reasoning ability to correct the response to obtain the correction result.

In the embodiment of the present disclosure, the first large model may be fine-tuned based on at least one of the above query, response, evaluation result or correction result. Here, fine-tuning may be minor modifications to parameters within the first large model. These parameters may include weight coefficients, bias terms, etc., which affect the feature extraction and decision-making process of the first large model for the input data (such as query, response, etc.). For example, if a hallucination phenomenon exists in the response of the first large model, the parameters related to reducing the hallucination phenomenon may be adjusted to enhance the accuracy of the first large model in processing the query.

In the above way, the evaluation and correction of the response by the first large model itself can discover possible errors or hallucinations in the response, and further, training the first large model based on the query, response, evaluation result and correction result can enhance the first large model's ability to respond and ability to evaluate responses, thereby improving the accuracy and reliability of the first large model.

Moreover, since the data for training the first large model is expanded based on the query, compared with the automatically synthesized sample data, the training data used in the method of the present disclosure can accurately reflect the specific scenario where the hallucination phenomenon occurs, thereby further improving the accuracy of the first large model in processing the query. Also, the training data used in the method of the present disclosure does not require manual annotation, reducing the application cost and improving the application efficiency.

In some implementations, the training method includes multiple iterations, and each iteration includes multiple steps from S210 to S230.

In the embodiment of the present disclosure, the determination of the first large model may be a process of continuous optimization and gradual performance improvement, which requires multiple iterations to achieve. Each iteration is a complete cycle training of the first large model, so that the first large model is continuously improved and optimized to better respond to various queries.

In each iteration, multiple steps from S210 to S230 may be performed sequentially. In one example, S210 is first executed to input a query into the first large model, and the first large model responds to the query based on its own knowledge reserves and algorithm logic, thereby obtaining a response to the query.

Further, the obtained query and the corresponding response are inputted into the first large model again, and the first large model is instructed to evaluate and correct the response. The first large model analyzes whether there is an error such as hallucination in the response and gives an evaluation result. At the same time, the first large model may also correct the erroneous response to obtain a correction result. It can be understood that if the evaluation result shows that there is no error in the response, the response may be directly used in the subsequent fine-tuning process of the first large model without being corrected.

Finally, S230 is executed to fine-tune the first large model for this iteration based on at least one of the query, the response, the evaluation result or the correction result. Here, fine-tuning may include adjusting the parameters of the first large model so that the first large model reaches a more optimal parameter state in this round of iteration.

In this way, the first large model can gradually optimize its own performance through multiple iterations. Since each iteration is performed based on the previous iteration, the first large model may be fine-tuned in a targeted manner according to the information obtained in the previous iteration. As the number of iterations increases, the first large model's ability to respond to queries and ability to evaluate and correct responses can be improved.

Moreover, multiple iterations can make the first large model contact with more different types of queries and responses, thereby enhancing the generalization ability of the first large model. In practical applications, the first large model may encounter different types of queries. Through multiple iterations for fine-tuning, the first large model learns the more extensive knowledge and can improve the performance in different scenarios.

In some implementations, before inputting the query to the first large model, the method further includes:
obtaining multiple sets of annotated data, where each set of annotated data includes a query, a response to the query, and an evaluation result of the response; and
fine-tuning a second large model using the multiple sets of annotated data to obtain the first large model.

In the embodiment of the present disclosure, inputting the query into the first large model is an important step in optimizing the first large model. Before inputting the query into the first large model, the acquisition of multiple sets of annotated data may be completed first, and the annotated data may be used to fine-tune the second large model to obtain the first large model.

In the embodiment of the present disclosure, the annotated data may be manually annotated data. Each set of annotated data contains three components: queries, responses to queries, and evaluation results of responses. Here, the queries may be various queries that users may raise in actual application scenarios; the responses are answers to these queries, and may be correct or incorrect; and the evaluation results are a measure of the quality of the responses, and may include a determination of whether there are errors in the responses.

In some implementations, the second large model includes a pre-trained multimodal large model.

In the embodiment of the present disclosure, the multimodal large model is a large model capable of processing the multimodal data, and can integrate information in different modalities such as text, image, voice and video, and understand the associations and semantics among these modal information, thereby realizing the interaction and reasoning of multimodal information.

In the embodiment of the present disclosure, by utilizing a large amount of general data (such as text, image, audio, etc.) to perform unsupervised or self-supervised training on the initial multimodal large model, the model can learn general knowledge representation in massive data, and then the second large model with basic capabilities is obtained to provide support for subsequent specific task execution. In other words, the second large model may be obtained by training on large-scale general data and has certain language understanding and generation capabilities, but is not fully suitable for specific tasks or scenarios.

Further, the second large model is fine-tuned by using the multiple sets of annotated data obtained above, so that the second large model adjusts its own parameters according to the queries, responses and evaluation results in these annotated data. Specifically, the second large model can predict the evaluation of the response based on the query and response, and compare the evaluation with the evaluation result in the annotated data, so that the second large model initially has the ability to evaluate the response, thus obtaining the first large model. In the above way, after being fine-tuned through the multiple sets of annotated data, the second large model has gained preliminary learning and understanding of a specific task (such as response evaluation task), improving the generalization ability of the second large model, and laying the foundation for subsequent multiple iterations for fine-tuning the first large model. Moreover, the annotation work only needs to be performed before the first iteration (that is, before the query is input into the first large model) (the data generated by the first large model is used as the training data in subsequent multiple iterations), and only a small amount of evaluation and fine-tuning data needs to be manually produced, so the labor cost is relatively low.

FIG. 3 is a schematic diagram of a process of training a large model according to an embodiment of the present disclosure. As shown in FIG. 3, the process of training the first large model may include the following steps.

S301: the first large model obtains a corresponding response according to a query and performs data sampling on the response.

In some implementations, the first large model includes a multimodal large model.

The query includes at least one of text content, voice content, image content or video content.

In the embodiment of the present disclosure, the query may include at least one of text content, voice content, image content or video content. Specifically, the query may be a request for a detailed interpretation of the content contained in an image, such as asking for the specific name of the scene or object presented in the image, or exploring the logical relationship and spatial position relationship among elements in the image, etc. Alternatively, the query may be a request for a detailed interpretation of the content contained in a video, such as asking for the meaning of a specific cultural symbol appearing in the video, the metaphorical meaning of a symbolic issue in the video, etc. In some implementations, inputting a query into the first large model so that the first large model responds to the query to obtain a response to the query, includes:
inputting a same query into the first large model multiple times, and adjusting a random parameter of the first large model, so that the first large model responds to the same query multiple times to obtain multiple responses to the same query.

In one example, a query containing at least one of text content, voice content, image content or video content may be input into a multimodal large model, to thereby obtain a result (i.e., response) output by the multimodal large model. Specifically, for the same query containing at least one of text content, voice content, image content or video content, multiple different responses may be obtained by calling the multimodal large model multiple times. This is because there is a certain degree of randomness within the large multimodal model when processing the complex multimodal information. In order to achieve this randomness and thus enrich the training data for fine-tuning the multimodal large model, the parameters related to the randomness (i.e., random parameters) in the multimodal large model may be appropriately adjusted, for example, parameters such as random seed and dropout involved in the reasoning process of the multimodal large model. By properly adjusting these parameters, the calculation path and decision-making method of each reasoning process of the multimodal large model can be changed, thereby generating differentiated results.

In some implementations, the first large model responds to the query to obtain a response to the query, including:
the first large model identifies semantic information in the text content or the voice content;
the first large model identifies a target object related to the semantic information in the image content or the video content, and generates description information for the semantic information according to the target object; and
the first large model determines the response to the query based on the description information.

In the embodiment of the present disclosure, the text content may be used to express a need for interpretation of at least one of the image content and the video content. Alternatively, the voice content may be used to express a need for interpretation of at least one of the image content and the video content. In one example, the voice-to-text conversion technology may be used to convert the voice content into the text content, thereby expressing the need for interpretation of at least one of the image content and the video content.

Further, the first large model uses the natural language processing technology to parse the input text or voice content and extract the semantic information (such as keyword, intention or emotional tendency) contained therein, laying the foundation for subsequent analysis.

Subsequently, the first large model may use the computer vision technology to identify a target object related to the semantic information for the input image content or video content (for example, locate a corresponding vehicle in the image or video according to the red car in the text description), and generate description information (for example, a red car is parked in the image with the front facing to the left) matching the semantic information based on the target object. Finally, the description information generated by the first large model serves as a response to the user's query to achieve the semantic information alignment and integration of multimodal information.

In this way, the multimodal large model processes the query, and extracts the correlation among multi-dimensional semantic information, visual features and multimodal data contained in the query, thereby obtaining multiple responses to the query. Further, the training data for fine-tuning the first large model may be constructed based on these responses, providing data support for improving the accuracy and performance of the first large model in processing queries.
S302: performing hallucination evaluation on the response based on the query and corresponding response to obtain an evaluation result.
S303: correcting the hallucination phenomenon in the response based on the query, response and evaluation result to obtain a correction result.
S304: constructing the first training data, second training data and third training data based on the query, response, evaluation result and correction result to fine-tune the first large model. The specific training data and fine-tuning method will be introduced in detail in the subsequent implementations.

In some implementations, inputting the query and the response into the first large model so that the first large model evaluates and corrects the response to obtain an evaluation result and a correction result of the response, includes:
inputting a hallucination evaluation prompt containing the query and the response into the first large model, so that the pre-trained first large model outputs the evaluation result of the response; and
inputting a hallucination correction prompt containing the query, the response and the evaluation result into the first large model, so that the pre-trained first large model outputs the correction result of the response.

In the embodiment of the present disclosure, the hallucination evaluation is intended to identify possible content that does not tally with the facts, has logical contradiction or departs from the input information in the response of the multimodal large model. Specifically, during the hallucination evaluation, the query and corresponding response can be obtained from S301, and then a hallucination evaluation prompt containing clear evaluation requirements and background information can be constructed. This hallucination evaluation prompt may illustrate the evaluation objective in details, such as judging whether the response is consistent with the information actually displayed in the image, whether a hallucination phenomenon occurs, etc.

Further, the query, the response and the constructed hallucination evaluation prompt are combined together and provided to the first large model as new input. The first large model analyzes the input content based on internal evaluation criteria and algorithms through semantic understanding and logical reasoning. Finally, the first large model outputs the evaluation result for the response, and the evaluation result may indicate whether there is a hallucination problem in the response.

It can be seen that the response to the query, the evaluation of the response and the correction of the response in the above process are all carried out by the first large model. The data generated by the first large model during each iteration may be used as the training data for fine-tuning the first large model during this iteration.

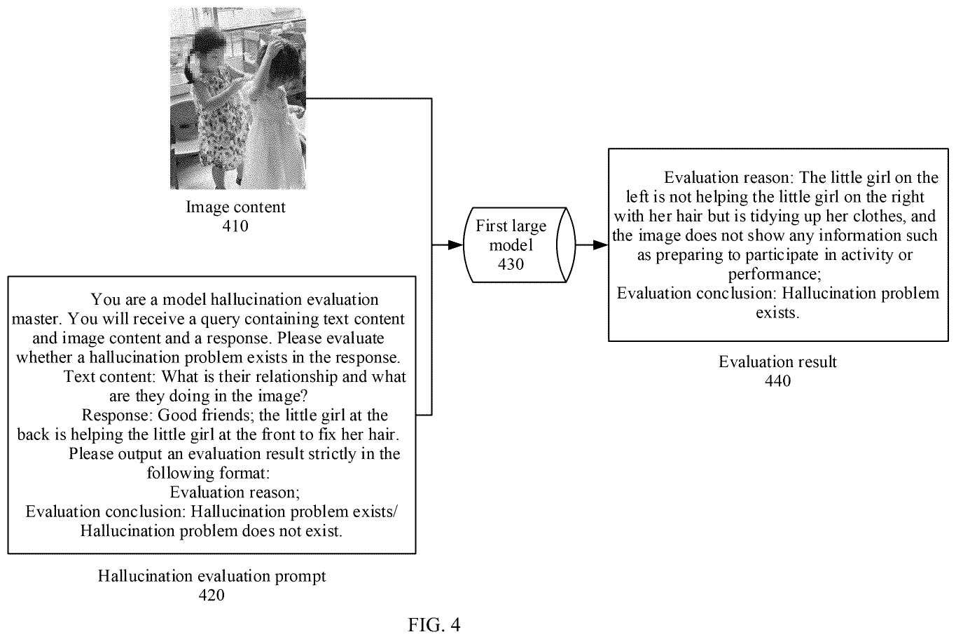

FIG. 4 is a schematic diagram of hallucination evaluation according to an embodiment of the present disclosure. As shown in FIG. 4, the image content 410 in the query and the hallucination evaluation prompt 420 may be input into the first large model 430. Here, the hallucination evaluation prompt 420 includes background information, text content in the query, a response to the query, and an evaluation requirement.

Further, the first large model 430 performs hallucination evaluation on the response according to the image content 410 and the hallucination evaluation prompt 420 to obtain an evaluation result 440.

For example, as shown in FIG. 4, the hallucination evaluation prompt 420 may be:
“You are a model hallucination evaluation master. You will receive a query containing text content and image content and a response. Please evaluate whether a hallucination problem exists in the response.
Text content: What is their relationship and what are they doing in the image?
Response: Good friends; the little girl at the back is helping the little girl at the front to fix her hair.
Please output an evaluation result strictly in the following format:
Evaluation reason;
Evaluation conclusion: Hallucination problem exists/Hallucination problem does not exist.”
Further, the first large model 430 may perform hallucination evaluation on the response after obtaining the image content 410 and the hallucination evaluation prompt 420. As shown in FIG. 4, the evaluation result 440 may be:
“Evaluation reason: The little girl on the left is not helping the little girl on the right with her hair but is tidying up her clothes, and the image does not show any information such as preparing to participate in activity or performance;
Evaluation conclusion: Hallucination problem exists.”

Here, it should be noted that, in the embodiment of the present disclosure, the first large model can be pre-trained (for example, the first large model is pre-trained using multiple sets of annotated data containing queries, responses and evaluation results) so that the first large model has the ability to perform hallucination evaluation on responses.

In the embodiment of the present disclosure, the hallucination correction aims to correct the response that is determined to have a hallucination problem based on the hallucination evaluation result, to ultimately obtain an accurate correction result without hallucinations. Specifically, the evaluation result for the response may be obtained from the hallucination evaluation stage, where the evaluation result indicates the evaluation reason and the evaluation conclusion. A hallucination correction prompt for performing hallucination correction on the response is constructed based on the query, the response and the evaluation result. The hallucination correction prompt contains the text information in the query, the background and requirement of the task, the response of the first large model to the query, and the evaluation result of the response.

Further, the hallucination correction prompt and the image content in the query are provided to the first large model, and the first large model uses its semantic understanding ability to parse various information in the hallucination correction prompt.

In one example, the first large model may re-examine the query to clarify the core intent and constraints of the query; then analyze the response sentence by sentence, and locate the hallucination part of the response in combination with the evaluation reason provided in the evaluation result; and finally, make the targeted correction to the erroneous content according to the knowledge learned in pre-training and the logical reasoning ability.

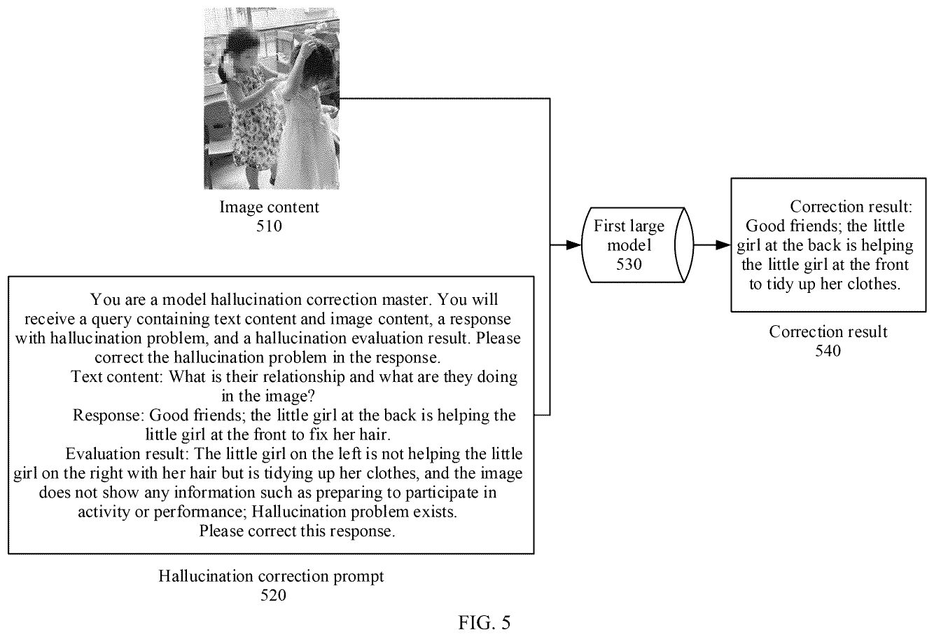

FIG. 5 is a schematic diagram of hallucination correction according to an embodiment of the present disclosure. As shown in FIG. 5, the image content 510 in the query and the hallucination correction prompt 520 may be input into the first large model 530. Here, the hallucination correction prompt 520 includes background information, text content in the query, a response to the query, an evaluation result of the response, and a correction requirement.

Further, the first large model 530 corrects the response with hallucination problem according to the image content 510 and the hallucination correction prompt 520 to obtain a correction result 540.

For example, as shown in FIG. 5, the hallucination correction prompt 520 may be:
“You are a model hallucination correction master. You will receive a query containing text content and image content, a response with hallucination problem, and a hallucination evaluation result. Please correct the hallucination problem in the response.
Text content: What is their relationship and what are they doing in the image?
Response: Good friends; the little girl at the back is helping the little girl at the front to fix her hair.
Evaluation result: The little girl on the left is not helping the little girl on the right with her hair but is tidying up her clothes, and the image does not show any information such as preparing to participate in activity or performance; Hallucination problem exists.
Please correct this response.”

Further, the first large model 530 may perform hallucination correction on the response with hallucination phenomenon after obtaining the image content 510 and the hallucination correction prompt 520. As shown in FIG. 5, the correction result 540 may be:
“Correction result: Good friends; the little girl at the back is helping the little girl at the front to tidy up her clothes.”

Here, it should be noted that, in the embodiment of the present disclosure, the first large model can be pre-trained (for example, the first large model is pre-trained using multiple sets of annotated data containing queries, responses, evaluation results and correction results) so that the first large model has the ability to perform hallucination correction on responses.

In the above way, by firstly performing hallucination evaluation on the response to clarify whether there is a hallucination phenomenon in the response and then correcting the response based on the evaluation result, the erroneous information output by the first large model can be reduced, and the reliability and response performance of the first large model can be improved. Moreover, the determination of the evaluation result and the correction result provides data support for subsequently fine-tuning the first large model.

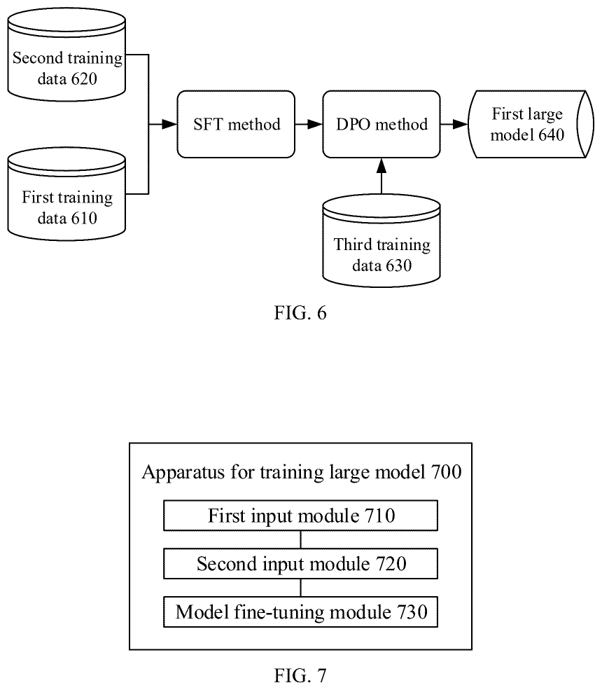

FIG. 6 is a schematic diagram of model fine-tuning according to an embodiment of the present disclosure. As shown in FIG. 6, the first large model 640 may be fine-tuned using the Supervised Fine-Tuning (SFT) method based on the first training data 610 and the second training data 620.

In some implementations, fine-tuning the first large model based on at least one of the query, the response, the evaluation result or the correction result, includes:
constructing multiple sets of first training data, where the first training data includes the query, the response and the evaluation result, and the evaluation result includes: the response is a response with hallucination or a response without hallucination; and
fine-tuning the first large model using the multiple sets of first training data.

In the embodiment of the present disclosure, the first training data 610 includes the query, the response and the evaluation result. Here, the response may be obtained from the aforementioned response sampling process, the evaluation result may be obtained from the aforementioned hallucination evaluation process, and the evaluation result includes: the response is a response with hallucination or a response without hallucination. In one example, the first training data includes both responses with hallucinations and their evaluation results, and responses without hallucinations and their evaluation results.

Further, the first large model 640 may be fine-tuned using the SFT method based on the first training data 610. Specifically, the query and response may be input data for training the first large model 640, and the first large model 640 encodes the input data and converts the image content and text content in the query into numerical representations that the first large model 640 can understand. After receiving the query and the response, the first large model 640 uses its internal reasoning mechanism to generate a predictive evaluation for the response by comprehensively considering the semantics of the query, the contextual information and the response, etc. The predictive evaluation may be a probability distribution or a specific category judgment to indicate the possibility of whether the response is a response with hallucination or a response without hallucination.

After the predictive evaluation is obtained, a suitable loss function may be selected to calculate the loss value between the predictive evaluation and the evaluation result. Here, the loss function may include but is not limited to mean square error, cross entropy loss, absolute value loss and Hinge loss, etc. The specific loss function may be determined according to the actual situation, and is not specifically limited in the present disclosure.

Further, using the calculated loss value, the loss value may be propagated forward layer by layer from the output layer of the first large model 640 through the back propagation algorithm, to calculate the gradient information of each parameter with respect to the loss value. The parameters of the model are updated using an optimization algorithm (such as stochastic gradient descent, etc.) according to the gradient information. Here, the optimization algorithm adjusts the parameter values according to the size and direction of the gradient so that the loss value gradually decreases, to improve the accuracy of the hallucination evaluation of the response by the first large model 640.

Using the above method, the first large model is fine-tuned by using multiple sets of first training data containing queries, responses and evaluation results, thus improving the accuracy of the hallucination evaluation of the response by the first large model 640, and simultaneously laying the foundation for determining the overall performance of the first large model. Moreover, the first training data does not require manual annotation, reducing the cost in constructing the first training data, and improving the degree of automation in fine-tuning the first large model.

In some implementations, fine-tuning the first large model based on at least one of the query, the response, the evaluation result or the correction result, further includes:
constructing multiple sets of second training data, where the second training data includes the query and a response without hallucination; and
fine-tuning the first large model using the multiple sets of second training data.

In the embodiment of the present disclosure, the second training data 620 includes a query and a response without hallucination. Here, in one example, the response without hallucination included in the second training data 620 is obtained based on the correction result, and the correction result may be obtained by the hallucination correction process. In other words, the correction result obtained after hallucination correction is an important source of the response without hallucination, and the correction result can be considered as the response without hallucination corresponding to the query. In another example, after the hallucination evaluation is performed on the response, if the evaluation result of the response includes the evaluation conclusion that “there is no hallucination problem”, then the response can be directly determined to be a response without hallucination.

In this way, the response without hallucination is obtained based on the correction result, making the response without hallucination consistent with the facts, reducing the noise and error information in the second training data, and thus reducing deviations caused by the first large model learning the error information.

Further, the first large model 640 may be fine-tuned using the SFT method based on the second training data 620. Specifically, the query may be input data for training the first large model 640, and the first large model 640 encodes the input data and converts the image content and text content in the query into numerical representations that the first large model 640 can understand. After receiving the query, the first large model 640 uses its internal reasoning mechanism to generate a predictive response to the query by comprehensively considering the semantics of the query, the contextual information, etc.

After the predictive response is obtained, a suitable loss function may be selected to calculate the loss value between the predictive response and the response without hallucination. Here, the loss function may include but is not limited to mean square error, cross entropy loss, absolute value loss and Hinge loss, etc. The specific loss function may be determined according to the actual situation, and is not specifically limited in the present disclosure.

Further, using the calculated loss value, the loss value may be propagated forward layer by layer from the output layer of the first large model 640 through the back propagation algorithm, to calculate the gradient information of each parameter with respect to the loss value. The parameters of the model are updated using an optimization algorithm (such as stochastic gradient descent, etc.) according to the gradient information. Here, the optimization algorithm adjusts the parameter values according to the size and direction of the gradient so that the loss value gradually decreases, to improve the accuracy of the hallucination evaluation of the response by the first large model 640.

In the above way, the first large model is fine-tuned by multiple sets of second training data containing queries and responses without hallucinations, so that the first large model can learn the characteristics of responses without hallucinations, thereby enhancing the sensitivity to hallucination content, thus reducing response deviations caused by hallucinations or error information, and improving the accuracy and reliability of responses. Moreover, the construction of the second training data does not require manual annotation, reducing the cost in constructing the second training data, and improving the degree of automation in fine-tuning the first large model.

Further, as shown in FIG. 6, after the first large model 640 is fine-tuned using the SFT method based on the first training data 610 and the second training data 620, the first large model 640 may be fine-tuned using the DPO method by constructing the third training data 630.

In some implementations, fine-tuning the first large model based on at least one of the query, the response, the evaluation result or the correction result, further includes:
constructing multiple sets of third training data, where the third training data includes the query, a response without hallucination to the query, and a response with hallucination to the query; and
fine-tuning the first large model using the multiple sets of third training data.

Here, in some implementations, the response without hallucination included in the third training data is obtained based on the correction result; and
the response with hallucination included in the third training data is obtained based on the evaluation result.

In one example, the response without hallucination in the third training data may be the correction result obtained after correcting the response to the query; or, in another example, after the hallucination evaluation is performed on the response to the query, if the evaluation result of the response includes the evaluation conclusion that “there is no hallucination problem”, then the response can be directly determined as the response without hallucination in the third training data.

In one example, if the evaluation result of the response to the query includes the evaluation conclusion that “there is a hallucination problem”, then the response corresponding to the evaluation result can be determined as the response with hallucination in the third training data.

In this way, the response without hallucination corresponding to the query can be determined based on the correction result, and the response with hallucination corresponding to the query can be determined based on the evaluation result, providing rich training samples for fine-tuning the first large model, and thereby improving the generalization ability of the first large model.

Further, the first large model 640 may be further trained using the DPO method based on the third training data 630 containing the query, the response without hallucination to the query, and the response with hallucination to the query.

Specifically, the first large model 640 can generate the response without hallucination and the response with hallucination to the query according to the query in the fine-tuning process.

Here, when the first large model 640 generates a response without hallucination, a positive reward may be given to the first large model 640 to enhance the ability of the first large model 640 to generate responses without hallucinations. Positive rewards may be diverse, including numerical reward increases or other feedback signals that are helpful for model optimization. Such positive rewards can encourage the first large model 640 to tend to generate similar responses without hallucinations. By continuously strengthening the ability to generate responses without hallucinations, the first large model 640 will gradually form a preference for generating responses without hallucinations, thereby improving the ability to generate accurate and reliable responses.

Simultaneously, contrary to the positive reward, when the first large model 640 generates a response with hallucination, a negative reward is given to the first large model 640. Through such negative rewards, the first large model 640 gradually recognizes the negative impact of responses with hallucinations in the fine-tuning process, and thus actively adjusts the generation strategy to reduce the generation of responses with hallucinations, thereby achieving the suppression of responses with hallucinations.

In the above way, the first large model is fine-tuned using the DPO method based on the third training data, so that the quality of the responses generated by the first large model can be improved, thereby alleviating the hallucination problem of the first large model and enhancing the stability and reliability of the first large model. Moreover, the third training data does not require manual annotation, reducing the cost in constructing the third training data, and improving the degree of automation in fine-tuning the first large model.

The method proposed in the present disclosure can enable the first large model to have the ability to automatically evaluate and correct responses, and simultaneously use the evaluation results and correction results combined with queries and responses to fine-tune the first large model through the SFT method and the DPO method, so that the alleviation of the hallucination problem of the first large model is achieved, and the alleviation effect is significant.

The embodiment of the present disclosure can use the aforementioned fine-tuning method for fine-tuning multiple times, that is, the training process includes multiple iterations until the first large model meets the actual performance requirements.

It can be understood that the second large model can be fine-tuned based on multiple sets of annotated data before the first iteration (i.e., before inputting a query into the first large model), so that the second large model has the ability to evaluate and correct hallucinations, thereby obtaining the first large model.

The method for training the large model proposed in the present disclosure can reduce the frequency of hallucination problems in the large model and support multiple automatic iterative optimizations, thereby achieving continuous reduction of hallucination problems in the large model. Also, the core goal of the present disclosure is to solve the hallucination problems of large models in various application scenarios, including but not limited to intelligent customer service, medical diagnosis assistance, financial analysis, educational guidance, media content generation and other fields. The method for training the large model proposed in the present disclosure can effectively eliminate the hallucination phenomena of large models, improve the reliability and accuracy of the content generated by large models, and thus promote the in-depth application of large models in a wider range of fields.

An embodiment of the present disclosure further provides an apparatus for training a large model. FIG. 7 is a structural schematic diagram of an apparatus for training a large model 700 according to an embodiment of the present disclosure, including:
a first input module 710 configured to input a query into a first large model so that the first large model responds to the query to obtain a response to the query;
a second input module 720 configured to input the query and the response into the first large model so that the first large model evaluates and corrects the response to obtain an evaluation result and a correction result of the response; and
a model fine-tuning module 730 configured to fine-tune the first large model based on at least one of the query, the response, the evaluation result or the correction result.

In some implementations, the model fine-tuning module 730 is configured to:
construct multiple sets of first training data, where the first training data includes the query, the response and the evaluation result, and the evaluation result includes: the response is a response with hallucination or a response without hallucination; and
fine-tune the first large model using the multiple sets of first training data.

In some implementations, the model fine-tuning module 730 is further configured to:
construct multiple sets of second training data, where the second training data includes the query and a response without hallucination; and
fine-tune the first large model using the multiple sets of second training data.

In some implementations, the response without hallucination included in the second training data is obtained based on the correction result.

In some implementations, the model fine-tuning module 730 is further configured to:
construct multiple sets of third training data, where the third training data includes the query, a response without hallucination to the query, and a response with hallucination to the query; and
fine-tune the first large model using the multiple sets of third training data.

In some implementations, the response without hallucination included in the third training data is obtained based on the correction result; and
the response with hallucination included in the third training data is obtained based on the evaluation result.

In some implementations, the first input module 710 is configured to:
input a same query into the first large model multiple times, and adjust a random parameter of the first large model, so that the first large model responds to the same query multiple times to obtain multiple responses to the same query.

In some implementations, the second input module 720 is configured to:
input a hallucination evaluation prompt containing the query and the response into the first large model, so that the pre-trained first large model outputs the evaluation result of the response; and
input a hallucination correction prompt containing the query, the response and the evaluation result into the first large model, so that the pre-trained first large model outputs the correction result of the response.

In some implementations, the model fine-tuning module 730 is further configured to:
obtain multiple sets of annotated data, where each set of annotated data includes a query, a response to the query, and an evaluation result of the response; and
fine-tune a second large model using the multiple sets of annotated data to obtain the first large model.

In some implementations, the second large model includes a pre-trained multimodal large model.

In some implementations, the first large model includes a multimodal large model; and the query includes at least one of text content, voice content, image content or video content.

In some implementations, the first large model identifies semantic information in the text content or the voice content;
the first large model identifies a target object related to the semantic information in the image content or the video content, and generates description information for the semantic information according to the target object; and
the first large model determines the response to the query based on the description information.

For the description of specific functions and examples of the modules and sub-modules of the apparatus of the embodiment of the present disclosure, reference may be made to the relevant description of the corresponding steps in the above-mentioned method embodiments, and details are not repeated here.

In the technical solution of the present disclosure, the acquisition, storage and application of the user's personal information involved are in compliance with relevant laws and regulations, and do not violate public order and good customs.

According to the embodiments of the present disclosure, the present disclosure also provides an electronic device, a readable storage medium and a computer program product.

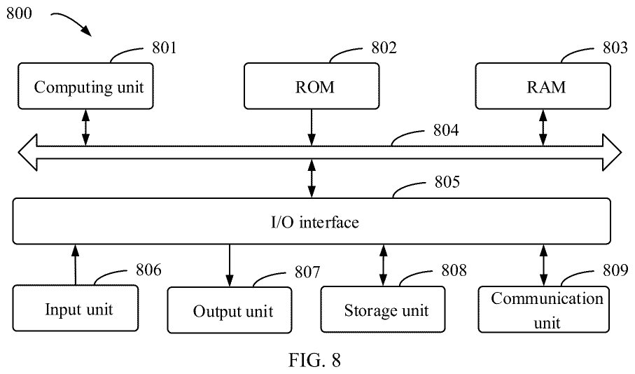

FIG. 8 shows a schematic block diagram of an exemplary electronic device 800 that may be used to implement the embodiments of the present disclosure. The electronic device is intended to represent various forms of digital computers, such as a laptop, a desktop, a workstation, a personal digital assistant, a server, a blade server, a mainframe computer, and other suitable computers. The electronic device may also represent various forms of mobile devices, such as a personal digital assistant, a cellular phone, a smart phone, a wearable device and other similar computing devices. The components shown herein, their connections and relationships, and their functions are merely examples, and are not intended to limit the implementation of the present disclosure described and/or required herein.

As shown in FIG. 8, the device 800 includes a computing unit 801 that may perform various appropriate actions and processes according to a computer program stored in a Read-Only Memory (ROM) 802 or a computer program loaded from a storage unit 808 into a Random Access Memory (RAM) 803. Various programs and data required for an operation of device 800 may also be stored in the RAM 803. The computing unit 801, the ROM 802 and the RAM 803 are connected to each other through a bus 804. The input/output (I/O) interface 805 is also connected to the bus 804.

A plurality of components in the device 800 are connected to the I/O interface 805, and include an input unit 806 such as a keyboard, a mouse, or the like; an output unit 807 such as various types of displays, speakers, or the like; the storage unit 808 such as a magnetic disk, an optical disk, or the like; and a communication unit 809 such as a network card, a modem, a wireless communication transceiver, or the like. The communication unit 809 allows the device 800 to exchange data with other devices through a computer network such as the Internet and/or various telecommunication networks.

The computing unit 801 may be various general-purpose and/or special-purpose processing components with processing and computing capabilities. Some examples of the computing unit 801 include, but are not limited to, a Central Processing Unit (CPU), a Graphics Processing Unit (GPU), various dedicated Artificial Intelligence (AI) computing chips, various computing units that run machine learning model algorithms, a Digital Signal Processor (DSP), and any appropriate processors, controllers, microcontrollers, or the like. The computing unit 801 performs various methods and processes described above, such as the method for training the large model. For example, in some implementations, the method for training the large model may be implemented as a computer software program tangibly contained in a computer-readable medium, such as the storage unit 808. In some implementations, a part or all of the computer program may be loaded and/or installed on the device 800 via the ROM 802 and/or the communication unit 809. When the computer program is loaded into the RAM 803 and executed by the computing unit 801, one or more steps of the method for training the large model described above may be performed. Alternatively, in other implementations, the computing unit 801 may be configured to perform the method for training the large model by any other suitable means (e.g., by means of firmware).

Various implementations of the system and technologies described above herein may be implemented in a digital electronic circuit system, an integrated circuit system, a Field Programmable Gate Array (FPGA), an Application Specific Integrated Circuit (ASIC), an Application Specific Standard Product (ASSP), a System on Chip (SOC), a Complex Programmable Logic Device (CPLD), a computer hardware, firmware, software, and/or a combination thereof. These various implementations may be implemented in one or more computer programs, and the one or more computer programs may be executed and/or interpreted on a programmable system including at least one programmable processor. The programmable processor may be a special-purpose or general-purpose programmable processor, may receive data and instructions from a storage system, at least one input device, and at least one output device, and transmit the data and the instructions to the storage system, the at least one input device, and the at least one output device.

The program code for implementing the method of the present disclosure may be written in any combination of one or more programming languages. The program code may be provided to a processor or controller of a general-purpose computer, a special-purpose computer or other programmable data processing devices, which enables the program code, when executed by the processor or controller, to cause the function/operation specified in the flowchart and/or block diagram to be implemented. The program code may be completely executed on a machine, partially executed on the machine, partially executed on the machine as a separate software package and partially executed on a remote machine, or completely executed on the remote machine or a server.

In the context of the present disclosure, a machine-readable medium may be a tangible medium, which may contain or store a procedure for use by or in connection with an instruction execution system, device or apparatus. The machine-readable medium may be a machine-readable signal medium or a machine-readable storage medium. The machine-readable medium may include, but is not limited to, an electronic, magnetic, optical, electromagnetic, infrared or semiconductor system, device or apparatus, or any suitable combination thereof. More specific examples of the machine-readable storage medium may include electrical connections based on one or more lines, a portable computer disk, a hard disk, a Random Access Memory (RAM), a Read-Only Memory (ROM), an Erasable Programmable Read-Only Memory (EPROM or a flash memory), an optical fiber, a portable Compact Disc Read-Only Memory (CD-ROM), an optical storage device, a magnetic storage device, or any suitable combination thereof.

In order to provide interaction with a user, the system and technologies described herein may be implemented on a computer that has: a display apparatus (e.g., a cathode ray tube (CRT) or a Liquid Crystal Display (LCD) monitor) for displaying to the user; and a keyboard and a pointing device (e.g., a mouse or a trackball) through which the user may provide input to the computer. Other types of devices may also be used to provide interaction with the user. For example, feedback provided to the user may be any form of sensory feedback (e.g., visual feedback, auditory feedback, or tactile feedback), and the input from the user may be received in any form (including an acoustic input, a voice input, or a tactile input).

The system and technologies described herein may be implemented in a computing system (which serves as, for example, a data server) including a back-end component, or in a computing system (which serves as, for example, an application server) including a middleware, or in a computing system including a front-end component (e.g., a user computer with a graphical user interface or web browser through which the user may interact with the implementation of the system and technologies described herein), or in a computing system including any combination of the back-end component, the middleware component, or the front-end component. The components of the system may be connected to each other through any form or kind of digital data communication (e.g., a communication network). Examples of the communication network include a Local Area Network (LAN), a Wide Area Network (WAN), and the Internet.

A computer system may include a client and a server. The client and server are generally far away from each other and usually interact with each other through a communication network. A relationship between the client and the server is generated by computer programs running on corresponding computers and having a client-server relationship with each other. The server may be a cloud server, a distributed system server, or a blockchain server.

It should be understood that, the steps may be reordered, added or removed by using the various forms of the flows described above. For example, the steps recorded in the present disclosure can be performed in parallel, in sequence, or in different orders, as long as a desired result of the technical scheme disclosed in the present disclosure can be realized, which is not limited herein.

The foregoing specific implementations do not constitute a limitation on the protection scope of the present disclosure. Those having ordinary skill in the art should understand that, various modifications, combinations, sub-combinations and substitutions may be made according to a design requirement and other factors. Any modification, equivalent replacement, improvement or the like made within the principle of the present disclosure shall be included in the protection scope of the present disclosure.

What is claimed is:

1. A method for training a large model, comprising:
inputting a query into a first large model, so that the first large model responds to the query to obtain a response to the query;
inputting the query and the response into the first large model, so that the first large model evaluates and corrects the response to obtain an evaluation result and a correction result of the response; and
fine-tuning the first large model based on at least one of the query, the response, the evaluation result or the correction result.

2. The method of claim 1, wherein the fine-tuning of the first large model based on at least one of the query, the response, the evaluation result or the correction result, comprises:
constructing multiple sets of first training data, wherein the first training data comprises the query, the response and the evaluation result, and the evaluation result comprises: the response is a response with hallucination or a response without hallucination; and
fine-tuning the first large model using the multiple sets of first training data.

3. The method of claim 2, wherein the fine-tuning of the first large model based on at least one of the query, the response, the evaluation result or the correction result, further comprises:
constructing multiple sets of second training data, wherein the second training data comprises the query and a response without hallucination; and
fine-tuning the first large model using the multiple sets of second training data.

4. The method of claim 3, wherein the response without hallucination comprised in the second training data is obtained based on the correction result.

5. The method of claim 2, wherein the fine-tuning of the first large model based on at least one of the query, the response, the evaluation result or the correction result, further comprises:
constructing multiple sets of third training data, wherein the third training data comprises the query, a response without hallucination to the query, and a response with hallucination to the query; and
fine-tuning the first large model using the multiple sets of third training data.

6. The method of claim 5, wherein:
the response without hallucination comprised in the third training data is obtained based on the correction result; and
the response with hallucination comprised in the third training data is obtained based on the evaluation result.

7. The method of claim 1, wherein the inputting of the query into the first large model so that the first large model responds to the query to obtain the response to the query, comprises:
inputting a same query into the first large model multiple times, and adjusting a random parameter of the first large model, so that the first large model responds to the same query multiple times to obtain multiple responses to the same query.

8. The method of claim 1, wherein the inputting of the query and the response into the first large model so that the first large model evaluates and corrects the response to obtain the evaluation result and the correction result of the response, comprises:
inputting a hallucination evaluation prompt containing the query and the response into the first large model, so that the pre-trained first large model outputs the evaluation result of the response; and
inputting a hallucination correction prompt containing the query, the response and the evaluation result into the first large model, so that the pre-trained first large model outputs the correction result of the response.

9. The method of claim 1, wherein before inputting the query into the first large model, the method further comprises:
obtaining multiple sets of annotated data, wherein each set of annotated data comprises a query, a response to the query, and an evaluation result of the response; and
fine-tuning a second large model using the multiple sets of annotated data to obtain the first large model.

10. The method of claim 9, wherein the second large model comprises a pre-trained multimodal large model.

11. The method of claim 1, wherein the first large model comprises a multimodal large model; and
the query comprises at least one of text content, voice content, image content or video content.

12. The method of claim 11, wherein the first large model responds to the query to obtain a response to the query, by:
the first large model identifies semantic information in the text content or the voice content;
the first large model identifies a target object related to the semantic information in the image content or the video content, and generates description information for the semantic information according to the target object; and
the first large model determines the response to the query based on the description information.

13. An electronic device, comprising:
at least one processor; and
a memory connected in communication with the at least one processor;
wherein the memory stores an instruction executable by the at least one processor, and the instruction, when executed by the at least one processor, enables the at least one processor to execute:
inputting a query into a first large model, so that the first large model responds to the query to obtain a response to the query;
inputting the query and the response into the first large model, so that the first large model evaluates and corrects the response to obtain an evaluation result and a correction result of the response; and
fine-tuning the first large model based on at least one of the query, the response, the evaluation result or the correction result.

14. The electronic device of claim 13, wherein the instruction, when executed by the at least one processor, enables the at least one processor to execute the fine-tuning of the first large model, by:
constructing multiple sets of first training data, wherein the first training data comprises the query, the response and the evaluation result, and the evaluation result comprises: the response is a response with hallucination or a response without hallucination; and
fine-tuning the first large model using the multiple sets of first training data.

15. The electronic device of claim 14, wherein the instruction, when executed by the at least one processor, enables the at least one processor to further execute the fine-tuning of the first large model, by:
constructing multiple sets of second training data, wherein the second training data comprises the query and a response without hallucination; and
fine-tuning the first large model using the multiple sets of second training data.

16. The electronic device of claim 15, wherein the response without hallucination comprised in the second training data is obtained based on the correction result.

17. A non-transitory computer-readable storage medium storing a computer instruction thereon, wherein the computer instruction is used to cause a computer to execute:
inputting a query into a first large model, so that the first large model responds to the query to obtain a response to the query;
inputting the query and the response into the first large model, so that the first large model evaluates and corrects the response to obtain an evaluation result and a correction result of the response; and
fine-tuning the first large model based on at least one of the query, the response, the evaluation result or the correction result.

18. The non-transitory computer-readable storage medium of claim 17, wherein the computer instruction is used to cause the computer to execute the fine-tuning of the first large model, by:
constructing multiple sets of first training data, wherein the first training data comprises the query, the response and the evaluation result, and the evaluation result comprises: the response is a response with hallucination or a response without hallucination; and
fine-tuning the first large model using the multiple sets of first training data.

19. The non-transitory computer-readable storage medium of claim 18, wherein the computer instruction is used to cause the computer to further execute the fine-tuning of the first large model, by:
constructing multiple sets of second training data, wherein the second training data comprises the query and a response without hallucination; and
fine-tuning the first large model using the multiple sets of second training data.

20. The non-transitory computer-readable storage medium of claim 19, wherein the response without hallucination comprised in the second training data is obtained based on the correction result.
